(19) United States
(12) Patent Application Publication
(10) Pub. No.: US 2007/0088699 A1
(43) Pub. Date: Apr. 19, 2007

(54) Multiple Pivot Sorting Algorithm

(76) Inventor: James Raymon Edmondson, Murfreesboro, TN (US)

Correspondence Address: James Raymon Edmondson, 1937 Middle Tennessee Blvd., Murfreesboro, TN, 37130, US

(21) Appl. No.: 11/163,427

(22) Filed: Oct. 18, 2005

(51) Int. Cl. G06F 7/00

(52) U.S. Cl. 707/7

(57) ABSTRACT

The invention relates to an O(n log n) recursive, comparison based sorting algorithm that uses multiple pivots to effectively partition a list of records into smaller partitions until the list is sorted. The algorithm is intended for use in software. This sorting method is accomplished by choosing pivot candidates from strategic locations in the list of records, moving those candidates to a section of the list of records (ie back or front of the large list) and sorting this small list. Then, the invention selects pivots from the pivot candidates and partitions the list of records around the pivots. Multiple Pivot Sort may be viewed as the next generation of Quick Sort, and average sorting times on unique random integer lists have beaten times by established algorithms like Quick Sort, Merge Sort, Heap Sort, and even Radix Sort.

### BACKGROUND OF INVENTION

1. Field of the Invention

The present invention relates to a process for sorting a list of records in software. Because this algorithm is comparison based, it is not limited to a specific data type or type of record.

2. Description of the Background Art

Sorting algorithms are one of the most useful and important assets to be produced from algorithm theory. They allow us to organize data logically for internal purposes (like determining medians or finding the first elements) and for display purposes (like printing a list of names to the screen so users can find a name in its corresponding spot in alphabetical order).

Sorting algorithms are not new topics to Computer Science. A version of Radix Sort was first used in the late 1800s in Hollerith's census machines. Versions of Merge Sort have been used in sorting operations done by hand or machine in environments like Post Offices since they were first established. Quick Sort and Heap Sort have been around since the late 1950s, and new derivatives of Quick Sort have been proposed as late as Multikey Quick Sort by Bentley and Sedgewick in 1997.

Despite all of this innovation and research, sorting algorithm development is not “done.” Quick Sort, still considered by many to be the fastest of the crop, still suffers from O(n²) behavior in both performance against lists of duplicates and certain patterns. Multikey Quick Sort fixes some aspects of the duplicate handling process but is really only applicable to strings and wastes overhead trying to find duplicates before even determining if such a condition might exist. Merge Sort and Heap Sort offer solid performance, but they are noticeably slower. In Computer Science, we are faced with a situation that offers many, many choices, but no real clear cut winner. Still, Quick Sort is used in libraries and industry because the rewards usually outweigh the risks. This is not to say that industry experts do not see Quick Sort perform badly. There is just no real, similar speed alternative.

### SUMMARY OF INVENTION

Multiple Pivot Sort, also known hereafter as M Pivot Sort or Pivot Sort, is a recursive comparison-based sorting algorithm that was developed to address shortcomings in current sorting algorithm theory. M Pivot Sort uses ideals from Probability and Statistics and the partitioning ideal from Quick Sort to offer the Computer Science field a sorting algorithm that is reliable and extremely quick on all data. M Pivot Sort is as fast as Quick Sort, can easily handle multiple duplicate records, and can be relied on in commercial applications to not exhibit O(n²) behavior.

M Pivot Sort accomplishes this by selecting a list of pivot candidates from the list population according to sampling guidelines. Specifically, the selection technique for M Pivot Sort can be seen as an extension of the Strong Law of Large Numbers. Because sample median is an unbiased estimator and variance of sample median decreases as sample size increases, on the average, the sample median is close to the population median. This is in stark contrast with Quick Sort which bases sample median solely on a single record chosen from the list.

These pivot candidates are isolated at either the front or back of the list and then sorted with an algorithm that works well on small lists (like Insertion Sort.) Selecting pivots from this sorted list requires no overhead. The second sorted candidate and every other candidate are selected as pivots, and the list is partitioned around these pivots. The algorithm is then called recursively on the sections of the list that are still unsorted.

### BRIEF DESCRIPTION OF DRAWINGS

FIG. 1 is a flowchart that depicts each call to Multiple Pivot Sort. The decision 109 is shown connecting to 101, even though in reality a call would be made to the same function, thus starting at 100. This is done to simplify the overview and mimic iterative behavior, even though this algorithm is not meant to be implemented as such.

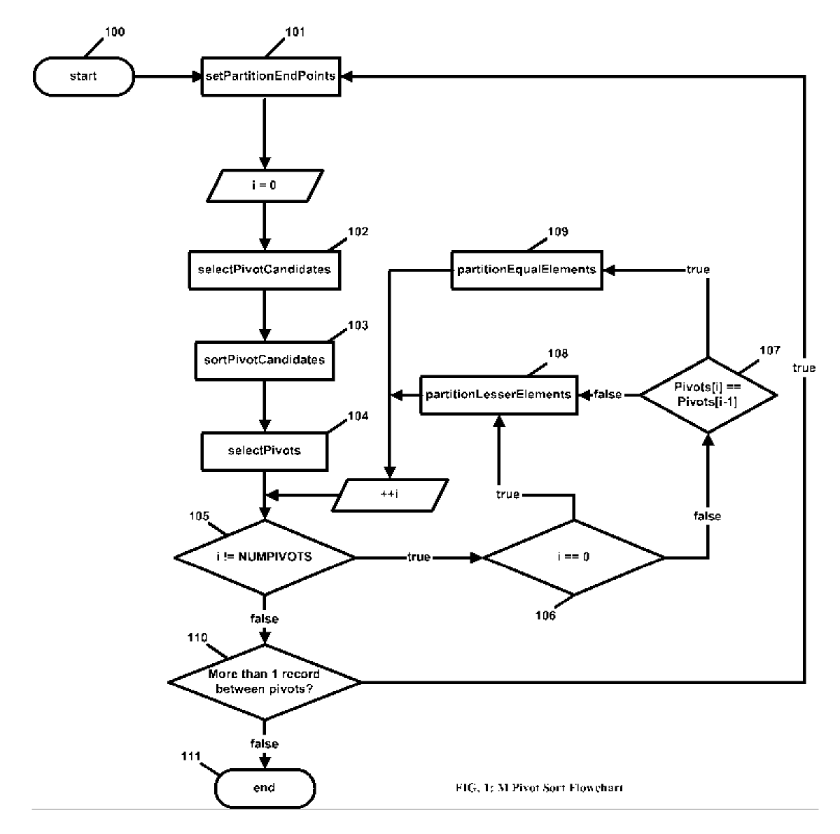

FIG. 2 is a drawing of proper pivot candidate selection techniques. The darkened areas represent pivot candidates for the type of selection. 202 (contiguous candidate selection) should only be used when the list is known to have completely random records. 200 and 201 (equidistant pairs and equidistant candidates) require very little overhead and are ideal candidates for selection techniques.

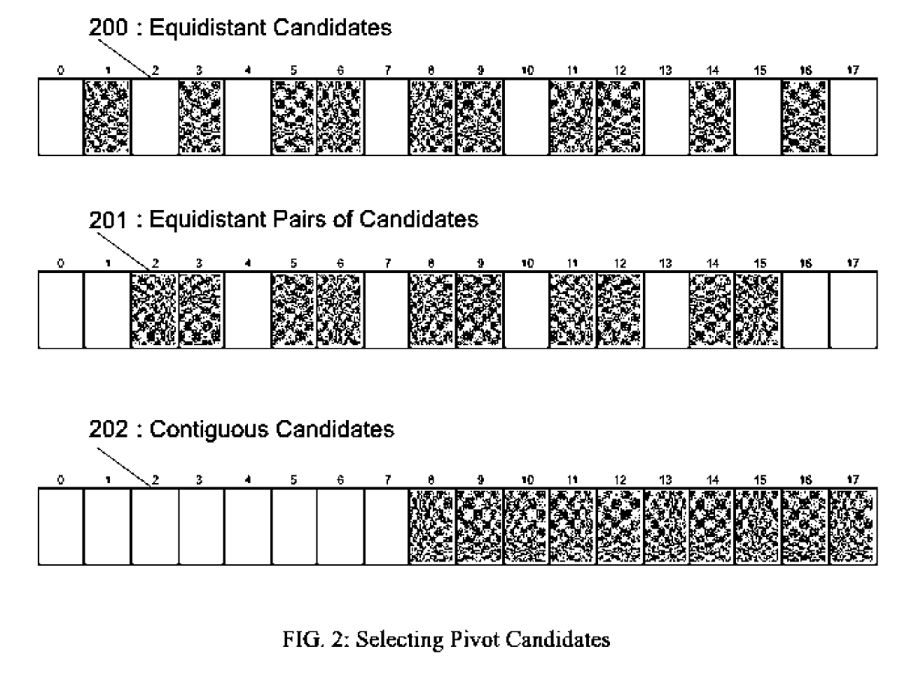

FIG. 3 is a drawing that describes the selection of pivots from the list of pivot candidates. In 300, the list of candidates is isolated (here it is shown at the end of the list) and then sorted with an algorithm like Insertion Sort (301). After the list is sorted (302), selecting pivots is passive and requires no overhead.

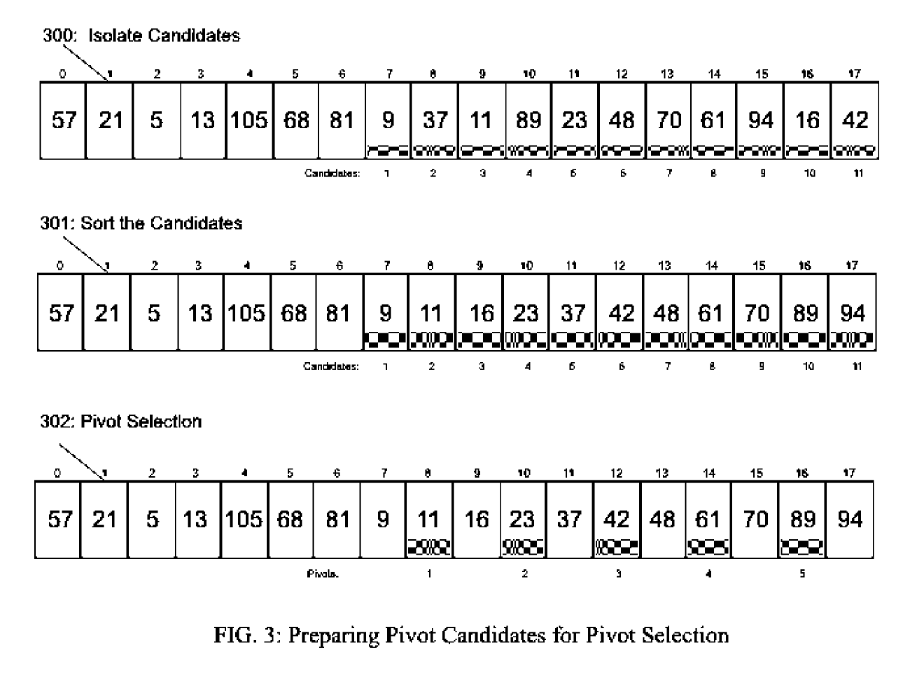

FIG. 4 is a drawing that depicts the contents of the list before and after partitioning around the pivots. 400 shows the pivots in respect to the rest of the list before partitioning. 401 shows the pivots in respect to the rest of the list after the pivots have been partitioned into their final placement. 402 shows the partitions that are left to sort. These partitions would be sorted through recursive calls to M Pivot Sort.

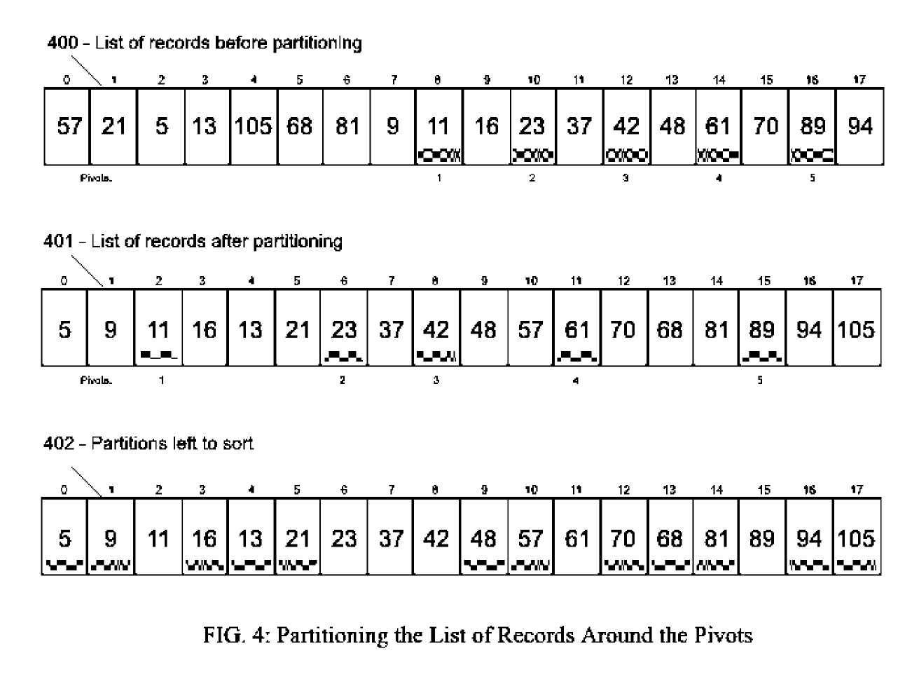

### DETAILED DESCRIPTION

Glossary

The following definitions may help illuminate the topics of discussion that follow.

Pivot candidate: A single record that has the potential to be a selected pivot. This is a new term proposed by the author and is specific to this invention. In relation to Quick Sort's Median-of-Three pivot selection routine, the three records that are compared to find a median could easily be termed pivot candidates, but no such distinction has been coined to the best of my knowledge.

Pivot or selected pivot: A special pivot candidate that has been selected to be a key in the partitioning phase.

Introduction

All figures and embodiments listed in this document concentrate on isolating pivot candidates at the end of the list for continuity and flow. This does not mean that the invention can not be implemented by placing candidates at the front of the list and partitioning around the later pivots first. Also, the pseudocode used in the Preferred Embodiments section is meant as a guide for programmers and not as the absolute end algorithm. Among the topics not covered in the presented pseudocode include building a min heap and a reverse max heap, handling skewed pivot lists with random generation of the number of pivots, and adjusting the PIVOTSORT declaration to include a number of pivots parameter. However, all of these optimizations are detailed in the sections that follow.

Software-Based Implementation

To sort a list of records, Pivot Sort first selects pivot candidates from the population. According to Statistical theory, these candidates should be sampled at strategic locations in the population (ie equidistant from each other in the array or equidistant pairs in the array), but Pivot Sort will also work with contiguous candidate selection (ie taking all pivot candidates from the front or rear of the list of records in a known random population.) After a selection policy is in place, Pivot Sort sorts this small list of pivot candidates with another sorting algorithm, one which has less overhead and works well on small lists. In theory, Insertion Sort is an excellent algorithm for sorting this small list of pivot candidates, but because of inherent flaws in the Insertion Sort algorithm, the size of the list of pivot candidates should not exceed 15 and should be an odd number. This forces Pivot Sort to use anywhere from two to seven pivots for effective and efficient partitioning. From extensive testing, five pivots have been shown to work most effectively.

After the list of pivot candidates has been sorted with an algorithm like Insertion Sort, pivots are selected from the pivot candidate list by selecting the 2^{nd} element and every two elements after. Because we are using odd numbers of candidates, this pivot selection method results in selecting pivots at locations that are guaranteed to have records between the pivots. This ideal is probabilistically sound and results in reliable partitioning by expanding on ideals of the Median-of-Three method commonly used in Quick Sort implementations. Pivot Sort is in many ways better than Quick Sort because it takes a larger sample size than Quick Sort which gives a much better chance of partitioning on a median value. If a list of pivot candidates is selected from equidistant locations in the list of records and pivots are selected as outlined earlier, the pivoting process is likely to produce better partitions.

Even though both M Pivot Sort and Quick Sort are based on the same partitioning principle that does not necessarily mean that they have the same optimal conditions. The odds that M Pivot Sort will partition the list identically to an optimal Quick Sort implementation are slim. M Pivot Sort's optimal situation is either this one (where performance is nearly identical to Quick Sort and the list is partitioned in halves for each pivot selected) or a near perfect snapshot of the list is taken with the selection of pivot candidates. The latter results in M Pivot Sort dividing the list into equal length partitions and is the ideal situation, resulting in less recursion and less overall work, especially in data moves.

The list is partitioned similarly to the method used in Quick Sort but around each of the pivots selected from the sorted list of candidates. In an ascending sort, all comparatively smaller records will be placed before the pivot and larger records will be placed after. However, unlike Quick Sort, Pivot Sort can handle duplicates by comparing pivots to each other. If two pivots are equal, then not only are those two pivots equal, but the pivot candidate that existed between them is equal. Instead of wasting comparisons for comparatively smaller records, Pivot Sort searches the list for equal records and places them between the previous pivot and current pivot. No recursion needs be done on the final partition between the equal pivots. On lists with large numbers of duplicates, Pivot Sort becomes an O(n) sorting algorithm, and the overhead of comparing pivots for equality is negligible.

After the partitioning process is complete, Pivot Sort is called recursively on those partitions that are not already sorted, resulting in a sorted list. Of note, because Pivot Sort performs more partitions per level, Pivot Sort performs less recursion than Quick Sort or Merge Sort—two industry standard comparison-based sorting algorithms. This results in a sorting algorithm with better memory management and a system that does not use as much stack space on function calls. Also, Pivot Sort can be tweaked to randomize the number of pivots (preferably between 3 and 7 because of the limits of Insertion Sort) if a worst case partition occurs, ie when a partition is skewed to one side (way more elements on the left than on the right.) Consequently, Pivot Sort is able to detect runtime problems, correct them, and proceed with partitioning. M Pivot Sort may be used in contiguous or queued schemes.

### PREFERRED EMBODIMENTS

As noted in the introduction, this pseudocode is meant as a guide to those who wish to implement aspects of this patent. The preferred embodiments listed here are not the only ways of implementing this algorithm, and this section is not intended to be complete and exhaustive.

Referring to claim 1, a preferred embodiment is the following:

PIVOTSORT(A,first,last)

| | |
|---|---|
| 1. | create array P [0 .. M−1] |
| 2. | if first < last and first >= 0 |

| | |
|---|---|
| 3. | then if first < last − 13 |

| | |
|---|---|
| 4. | then CHOOSEPIVOTS(A,first,last,P) |

| | |
|---|---|
| 5. | INSERTIONSORT(A,P[0]−1,last) |
| 6. | nextStart [symbol] first |
| 7. | for I [symbol] 0 to M−1 |

| | |
|---|---|
| 8. | do curPivot [symbol] P[i] |

| | |
|---|---|
| 9. | nextGreater [symbol] nextStart |
| 10. | nextGreater [symbol] PARTITION(A,nextStart,nextGreater,curPivot) |
| 11. | exchange A[nextGreater] [symbol] A[curPivot] |
| 12. | exchange A[nextGreater+1] [symbol] A[curPivot+1] |
| 13. | if nextStart == first and P[i] > nextStart+1 |

| | |
|---|---|
| 14. | then PIVOTSORT(A,nextStart,P[i]−1) |

| | |
|---|---|
| 15. | if nextStart != first and P[i] > P[i−1]+2 |

| | |
|---|---|
| 16. | then PIVOTSORT(A,P[i−1]+1,P[i]+1) |

| | |
|---|---|
| 17. | nextStart [symbol] nextGreater + 2 |

| | |
|---|---|
| 18. | if last > P[M−1]+1 |

| | |
|---|---|
| 19. | then PIVOTSORT(A, P[M−1]+1,last) |

| | |
|---|---|
| 20. | else INSERTIONSORT(A,first,last) |

CHOOSEPIVOTS(A,first,last,P)

| | |
|---|---|
| 1. | size [symbol] last−first+1 |
| 2. | segments [symbol] M+1 |
| 3. | candidate [symbol] size / segments − 1 |
| 4. | if candidate >= 2 |

| | |
|---|---|
| 5. | then next [symbol] candidate + 1 |
| 6. | else next [symbol] 2 |

| | |
|---|---|
| 7. | candidate [symbol] candidate + first |
| 8. | for i [symbol] 0 to M−1 |

| | |
|---|---|
| 9. | do P[i] [symbol] candidate |

| | |
|---|---|
| 10. | candidate [symbol] candidate + next |

| | |
|---|---|
| 11. | for i [symbol] M−1 to 0 |

| | |
|---|---|
| 12. | do exchange A[P[i]+1] [symbol] A[last] |

| | |
|---|---|
| 13. | last [symbol] last−1 |
| 14. | exchange A[P[i]] [symbol] A[last] |
| 15. | last [symbol] last−1 |

PARTITION(A,nextStart,nextGreater,curPivot)

| | |
|---|---|
| 1. | for curUnknown [symbol] nextStart to curPivot−1 |

| | |
|---|---|
| 2. | do if A[curUnknown] < A[curPivot] |

| | |
|---|---|
| 3. | exchange A[curUnknown] [symbol] A[nextGreater] |
| 4. | nextGreater [symbol] nextGreater + 1 |

| | |
|---|---|
| 5. | return nextGreater |

Referring to Claim 3 and including the algorithm highlighted in Claim 1, the preferred embodiment is the following:

PIVOTSORT(A,first,last)

| | |
|---|---|
| 1. | create array P [0 .. M−1] |
| 2. | if first < last and first >= 0 |

| | |
|---|---|
| 3. | then if first < last − 13 |

| | |
|---|---|
| 4. | then CHOOSEPIVOTS(A,first,last,P) |

| | |
|---|---|
| 5. | INSERTIONSORT(A,P[0]−1,last) |
| 6. | nextStart [symbol] first |
| 7. | for i [symbol] 0 to M−1 |

| | |
|---|---|
| 8. | do curPivot [symbol] P[i] |

| | |
|---|---|
| 9 | nextGreater [symbol] nextStart |
| 10. | if nextStart != first and A[P[i−1]] == A[P[i]] |

| | |
|---|---|
| 11. | then nextGreater [symbol] PIVOTEQUALSLEFT(A,nextStart,nextGreater,curPivot) |
| 12. | while i < M and A[P[i−1] == A[P[i]] |

| | |
|---|---|
| 13. | do exchange A[nextGreater] [symbol] A[curPivot] |

| | |
|---|---|
| 14. | exchange A[nextGreater+ 1] [symbol] A[curPivot+1] |
| 15. | P[i] [symbol] nextGreater |
| 16. | nextStart [symbol] nextGreater + 2 |
| 17. | i [symbol] i + 1 |
| 18. | curPivot [symbol] P[i] |
| 19. | nextGreater [symbol] nextStart |

| | |
|---|---|
| 20. | i [symbol] i − 1 |

| | |
|---|---|
| 21. | else |

| | |
|---|---|
| 22. | then nextGreater [symbol] PIVOTSMALLERLEFT(A,nextStart,nextGreater,curPivot) |

| | |
|---|---|
| 23. | P[i] [symbol] nextGreater |
| 24. | nextStart [symbol] nextGreater + 2 |
| 25. | if nextStart == first and P[i] > nextStart+1 |

| | |
|---|---|
| 26. | then PIVOTSORT(A,nextStart,P[i]−1) |

| | |
|---|---|
| 27. | if nextStart != first and P[i] > P[i−1]+2 |

| | |
|---|---|
| 28. | then PIVOTSORT(A,P[i−1]+1,P[i]+1) |

| | |
|---|---|
| 29. | nextStart [symbol] nextGreater + 2 |

| | |
|---|---|
| 30. | if last > P[M−1]+1 |

| | |
|---|---|
| 31. | then PIVOTSORT(A, P[M−1]+1,last) |

| | |
|---|---|
| 32. | else INSERTIONSORT(A,first,last) |

CHOOSEPIVOTS(A,first,last,P)

| | |
|---|---|
| 1. | size [symbol] last−first+1 |
| 2. | segments [symbol] M+1 |
| 3. | candidate [symbol] size / segments − 1 |
| 4. | if candidate >= 2 |

| | |
|---|---|
| 5. | then next [symbol] candidate + 1 |
| 6. | else next [symbol] 2 |

| | |
|---|---|
| 7. | candidate [symbol] candidate + first |
| 8. | for i [symbol] 0 to M−1 |

| | |
|---|---|
| 9. | do P[i] [symbol] candidate |

| | |
|---|---|
| 10. | candidate [symbol] candidate + next |

| | |
|---|---|
| 11. | for i [symbol] M−1 to 0 |

| | |
|---|---|
| 12. | do exchange A[P[i]+1] [symbol] A[last] |

| | |
|---|---|
| 13. | last [symbol] last−1 |
| 14. | exchange A[P[i]] [symbol] A[last] |
| 15. | last [symbol] last−1 |

PIVOTSMALLERLEFT(A,nextStart,nextGreater,curPivot)

| | |
|---|---|
| 1. | for curUnknown [symbol] nextStart to curPivot−1 |

| | |
|---|---|
| 2. | do if A[curUnknown] == A[curPivot] |

| | |
|---|---|
| 3. | exchange A[curUnknown] [symbol] A[nextGreater] |
| 4. | nextGreater [symbol] nextGreater + 1 |

| | |
|---|---|
| 5. | return nextGreater |

PIVOTEQUALSLEFT(A,nextStart,nextGreater,curPivot)

| | |
|---|---|
| 1. | for curUnknown [symbol] nextStart to curPivot−1 |

| | |
|---|---|
| 2. | do if A[curUnknown] < A[curPivot] |

| | |
|---|---|
| 3. | exchange A[curUnknown] [symbol] A[nextGreater] |
| 4. | nextGreater [symbol] nextGreater + 1 |

| | |
|---|---|
| 5. | return nextGreater |

Claim 2 can be implemented in many forms. However, checking for the conditions necessary to call on such a correction method is easy to describe. During the partition phase, code must be written that checks where the pivots end up. Although a thorough system of checks may seem attractive, it is discouraged because it is unnecessary. Instead, a check should only be made after the pivots reach their final destinations, and PIVOTSORT should not be called recursively on the sorted partitions until after the check has been made. The latter means that instead of the above code which combines the partition and recursive calls to PIVOTSORT, the partitioning phase would be clearly delineated between the following steps:

1. Partition the list around the selected pivots.

2. Check for a skewed pivot list. The worst case will be the last selected pivot ending up close to the front of the list (say in the first quarter of the list). A less dire worst case will be the first selected pivot ending up close to the end of the list, but in this case with 5 pivots used, at least 10 elements have been sorted on this level while only really requiring the work done on the first selected pivot. Still, this is a worst case and O(n²) behavior, though a fraction of the worst case of algorithms like Insertion Sort, Quick Sort, Bubble Sort, etc.

3. If the pivot list is not skewed, just partition the list. No problems have been encountered. However, if the list is skewed, either build a min heap and reverse max heap or either one of the two, or more preferably, change the number of pivots for the next level of partitioning. This is the easiest and best way to change the sampling and correct run time performance. If the number of pivots was five and now it is three, the algorithm is selecting pivot candidates from completely different areas of the list with no real overhead (one random number generated with a modulus of the maximum number of pivots allowed, which is determined by the method used to sort the list of pivot candidates.) This is a sure way to beat any pattern that might have resulted in a worst case for the Pivot Sort algorithm, and in practice, results in an algorithm that does not go into exponential time.

What is claimed is:

1. A method for sorting a list of records comprising the steps of:
selecting pivot candidates from the list of records;
moving the list of pivot candidates to the front or rear of the list of records;
sorting the small list of pivot candidates with another algorithm like Insertion Sort;
selecting pivots from the sorted list of pivot candidates;
partitioning the list of records around the pivots;
repeating steps for each unsorted partition.

2. A method for improving the software algorithm in claim 1 that optimizes the algorithm to deal with worst case pivot candidate sampling during runtime. During the partition phase, the algorithm checks for a skewed pivot list (ie chosen pivots ending up bunched to the front or end of the population list), and either corrects the situation by building a min heap or reverse max heap out of the population list, or simply changes the number of pivots, thus dynamically changing the sampling area throughout the list. Both prevent the patterned worse cases, like spikes at the sampling areas.

3. A method for improving the software algorithm in claim 1 involving comparing the current pivot about to be partitioned with the last pivot, and if these two pivots are equal, pivoting equal records remaining in the unpartitioned list between the previous pivot and the current pivot. This improvement handles duplicate records during runtime and adds very little overhead.
